(19) United States
(12) Patent Application Publication
(10) Pub. No.: US 2005/0009377 A1
(43) Pub. Date: Jan. 13, 2005

(54) Pick up cap used for a land grid array connector

(76) Inventor: Fang-Jwu Liao, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/887,773

(22) Filed: Jul. 9, 2004

(30) Foreign Application Priority Data
Jul. 9, 2003 (TW) 92212596

(51) Int. Cl. H01R 13/60

(52) U.S. Cl. 439/41

(57) ABSTRACT

An LGA connector assembly (10) includes an LGA connector body (12) and a pick up cap (13). The LGA connector includes a connector body (20), a load lever (26) received in a first end wall (201) of connector body, and a clip (24) pivotally mounted to a second end wall (203) of the connector body. The connector body defines a first mark (205) in the first end wall thereof. The pick up cap includes a body plate (30) having a smooth flat top surface (300) and a bottom surface (301), a second mark (302) extending from the top surface to the bottom surface. An orientation that the first mark of the connector body points to is the same as an orientation that the second mark of the pick up cap points to, so that the pick up cap can be correctly mounted on the connector.

### BACKGROUND OF THE INVENTION

1. Field of the Invention

The present invention relates to a land grid array (LGA) connector assembly, and particularly to an LGA connector assembly having a pick up cap with a mark used for manipulating an LGA connector onto an underlying electronic device.

2. Description of Prior Art

Electronic components such as land grid array (LGA) connectors are accurately positioned on underlying electronic devices such as printed circuit boards (PCBs) by means of vacuum suction devices. Such an LGA connector typically comprises a connector body, a plurality of electrical contacts received in the connector body, a metal clip pivotably attached to an end of the connector body, and a load lever received in an opposite end of the connector body. The clip has a generally rectangular window in a center thereof. In assembly, an LGA chip is received in the connector body of the LGA connector. The clip presses the LGA chip on the connector body, and the load lever presses the clip. Because of the window of the clip, a pick up cap is attached on the clip and the vacuum suction device is manipulated on a top surface of the pick up cap so as to properly position the LGA connector onto the PCB. The pick up cap typically has a body plate covering the LGA connector, and a plurality of latch members depending from the body plate for clasping corresponding sidewalls of the LGA connector, thereby mounting the pick up cap onto the LGA connector. The body plate has a smooth flat top so that the vacuum suction device is then able to engage on the flat top surface of the pick up cap, in order to reliably move and accurately position the LGA connector onto the PCB.

However, such pick up cap has no mark on the top surface of the body plate thereof, the pick up cap is liable to be incorrectly mounted on the LGA connector. When this happens, the LGA connector is attached incorrectly to the PCB. This results in wastage of products.

A new pick up cap that overcomes the above-mentioned problems is desired.

### SUMMARY OF THE INVENTION

An object of the present invention is to provide an LGA connector assembly having a LGA connector with a first mark and a pick up cap with a second mark, so that the pick up cap is correctly mounted on the LGA connector.

In order to achieve the above object, an LGA connector assembly in accordance with a preferred embodiment of the present invention comprises an LGA connector and a pick up cap. The LGA connector comprises a connector body having a first end wall and a second end wall, a clip pivotally mounted to the second end wall of the connector body, and a load lever received in the first end wall of connector body. The first end wall defines a first mark in one end thereof. The pick up comprises a body plate having a smooth flat top surface and a bottom surface. The body plate defines a second mark extending from the top surface to the bottom surface. That an orientation that the first mark of the connector body points to is the same as an orientation that the second mark of the pick up cap points to indicates the pick up cap in correctly mounted on the connector.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified, exploded isometric view of a connector assembly in accordance with the preferred embodiment of the present invention;

FIG. 2 is an enlarged, inverted view of a pick up cap of the connector assembly of FIG. 1, but viewed from a different aspect;

FIG. 3 is an enlarged, assembled view of the pick up cap and a clip of the connector assembly of FIG. 1, but viewed from an opposite aspect; and

FIG. 4 is an enlarged, assembled view of FIG. 1.

### DESCRIPTION OF THE PREFERRED EMBODIMENT

Reference will now be made to the drawings to describe the present invention in detail.

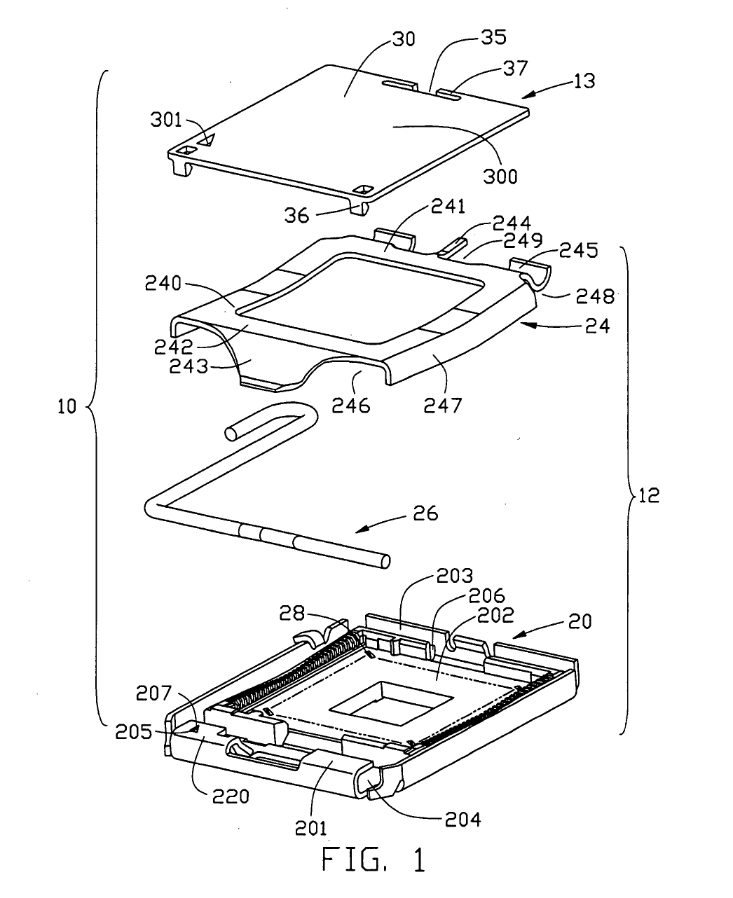

FIG. 1 shows an LGA connector assembly 10 in accordance with the preferred embodiment of the present invention. The LGA connector assembly 10 comprises an LGA connector 12 mounted on a substrate circuit, such as a printed circuit board (PCB) (not shown), and a pick up cap 13 attached to the LGA connector 12.

The LGA connector 12 is adapted for electrically connecting an electronic package such as a land grid array (LGA) chip (not shown) with the PCB. The LGA connector 12 comprises a generally rectangular connector body 20, a plurality of conductive contacts 28 received in the connector body 20, a load lever 26 engaged with the connector body 20, and a metal clip 24 pivotably mounted to the connector body 20.

The connector body 20 comprises a main portion 202 for receiving the LGA chip, a first end wall 201, a second end wall 203 opposite to the first end wall 201, and a pair of opposite sidewalls (not labeled) interconnecting the first end wall 201 and the second end wall 203. The main portion 202 defines a plurality of passageways (not labeled) arranged in a rectangular array, for receiving the plurality of terminals 28 therein. The second end wall 203 defines a pair of spaced pivot apertures 206 for pivotably mounting the clip 24. The first end wall 201 defines a receiving groove 204 for receiving the load lever 26, and a triangular first mark 205 in one end thereof. A first angle 207 of the first mark 205 points to an opposite end of the first end wall 201.

The clip 24 is pivotally mounted to the second end wall 203 of the connector body 20, and comprises a main body 240 defining an opening (not labeled) in a middle thereof. The main body 240 comprises a first end portion 242 corresponding to the first end wall 201 of the connector body 20, an opposite second end portion 241 corresponding to the second end wall 203 of the connector body 20, and a pair of opposite side portions (not labeled) interconnecting the first and second end portions 242, 241. A pair of spaced, curved pivot latches 245 extends outwardly from two spaced ends of the second end portion 241 corresponding to the pivot apertures 206 of the first end portion 203, thereby forming a pair of locating cutouts 248 at out side of each thereof. A tail portion 244 extends outwardly from a middle portion of the second end portion 241 between the pivot latches 245, thereby forming a pair of second cutouts 249 between the tail portion 244 and the two pivot latches 245. A hook portion 243 extends from a middle portion of the first end portion 242, thereby forming a pair of first cutouts 246 at two out sides thereof. A pair of opposite side plates 247 depends from edges of the opposite side portions respectively, for pressing the LGA chip on the connector body 20.

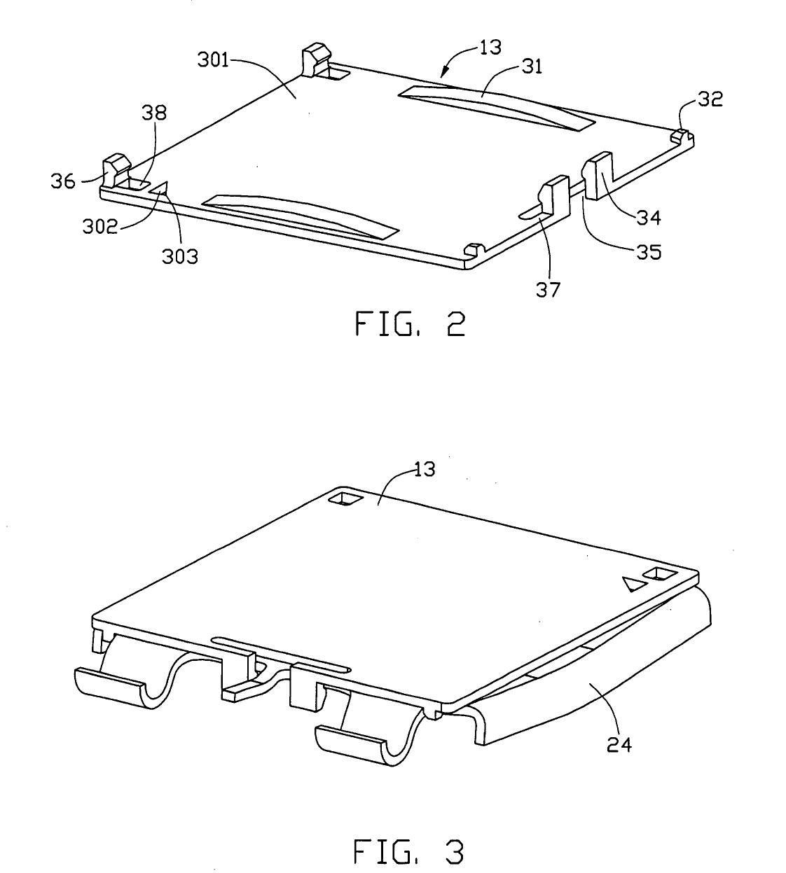

Referring also to FIG. 2, the pick up cap 13 is a substantially rectangular plate, comprises a rectangular planar body plate 30. The body plate 30 comprises a smooth flat top surface 300 facilitating a vacuum suction device (not shown) sucking the pick up cap 13, and a bottom surface 301 opposite to the top surface 300. A pair of spaced first clasps 36 depends from one end of the body plate 30 at the bottom surface 301, corresponding to the first cutouts 246 of the clip 24. A pair of through hole 38 is defined in the body plate 30 adjacent to the first clasps 36, thereby the first clasps 36 having good resilience. A T-shaped channel 35 is defined in an opposite end of the body plate 30 at the bottom surface 301, thereby forming a pair of resilient arms 37 at opposite ends thereof. A pair of spaced second clasps 34 depends from corresponding distal ends of the arms 37 at the bottom surface 301, corresponding to the second cutouts 249 of the clip 24. A pair of locating projections 32 extends vertically from the body plate 30 at the bottom surface 301 opposite to the first clasps 36, corresponding to the locating cutout 248 of the clip 24. A pair of arcuate ribs 31 depends from corresponding middle portions of opposite sides of the body plate 30 at the bottom surface 301. A triangular second mark 302 is defined in the planar portion 30 proximate to one of the first clasps 36. The second mark 302 extends from the top surface 300 to the bottom surface 301. A second angle 303 of the second mark 302 points to one of the locating projections 32. Thus, an orientation that the first mark 205 of the LGA connector 20 points to is the same as an orientation that the second mark 302 of the pick up cap 13 points to.

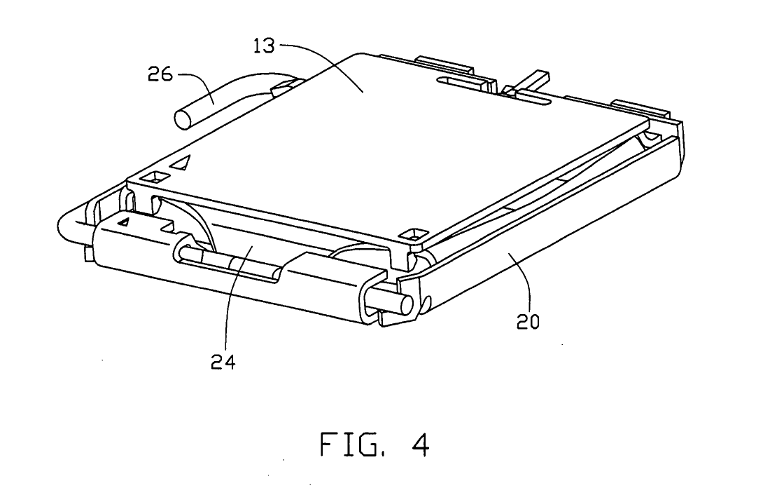

Referring particularly to FIGS. 3 and 4, in assembly, the pivot latches 245 of the clip 24 are pivotally attached to the corresponding pivot apertures 206 of the second end wall 203 of the connector body 20. The load lever 26 is received in the receiving groove 204 of the first end wall 201 of the connector body 20. The LGA chip is received in the main portion 202 of the connector body 20. The side plates 247 of the clip 24 press the LGA chip on the main portion 202 of the connector body 20, and the load lever 26 presses the hook portion 243 of the clip 24. The pick up cap 13 is mounted on the clip 24. In attaching of the pick up cap 13 onto the clip 24, the orientation of the second angle 303 of the second mark 302 is aimed at the orientation of the first angle 207 of first mark 205 of the connector body 20 so that the pick up cap 13 can be correctly disposed over the clip 24. The first clasps 36 and second clasps 34 loosely contact corresponding edges of the first cutouts 246 and the second cutouts 249 of the clip 24 respectively. The pick up cap 13 is pressed down. The first clasps 36 and second clasps 34 are elastically deflected outwardly. When the ribs 31 of the pick up cap 13 is attached on the clip 24 and the tail portion 244 of the clip 24 is received in the channel 35 of the pick up cap 13, the first clasps 36 and second clasps 34 resiliently snap the corresponding edges of the first cutouts 246 and the second cutouts 249 of the clip 24 respectively, and the locating projections 32 abut against edges the locating cutouts 248 of the clip 24, thereby securely mounting the pick up cap 13 onto the clip 24. Thus, the vacuum suction device can suck the top surface 300 of the pick up cap 13 in order to move the LGA connector 12 to a desired location on the PCB.

Unlike the conventional LGA connector assembly, the LGA connector assembly 10 has the first mark 205 of the connector body 20 and the second mark 302 of the pick up cap 13, and the orientation that the second mark 302 of the pick up cap 13 points to is the same as the orientation that the first mark 205 of the connector body 20 points to. This configuration can insure correctly attachment of the pick up cap 13 onto the LGA connector 20. As a result, the LGA connector assembly 10 is accurately mounted on the PCB.

While a preferred embodiment in accordance with the present invention has been shown and described, equivalent modifications and changes known to persons skilled in the art according to the spirit of the present invention are considered within the scope of the present invention as defined in the appended claims.

1. A connector assembly comprising:
a connector comprising a connector body having a first end wall and a second end wall, a clip pivotally mounted to the second end wall of the connector body, and a load lever received in the first end wall of the connector body, the first end wall defining a first mark in one end thereof; and
a pick up cap comprising a body plate having a top surface and a bottom surface, the body plate defining a second mark;
wherein that an orientation that the first mark of the connector body points to is the same as an orientation that the second mark of the pick up cap points to indicates the pick up cap in correctly mounted on the connector.

2. The connector assembly as claimed in claim 1, wherein the pick up cap comprises a pair of spaced first clasps depending from one end of the body plate at the bottom surface thereof, a pair of through holes defined in the body plate adjacent to the corresponding first clasps, a T-shaped channel defined in an opposite end of the body plate thereby forming a pair of resilient arms at opposite ends thereof, a pair of second clasps depending from corresponding ends of the resilient arms at the bottom surface thereof, a pair of spaced locating projections extending vertically from the body plate at the bottom surface opposite to the first clasps respectively, and a pair of ribs extending from opposite sides of the body plate at the bottom surface thereof.

3. The connector assembly as claimed in claim 2, wherein the top surface is smooth and flat.

4. The connector assembly as claimed in claim 3, wherein the first mark of the connector and the second mark of the pick up cap are substantially triangular, respectively.

5. The connector assembly as claimed in claim 4, wherein a first angle of the first mark of the connector points to an opposite end of the end wall of the connector body.

6. The connector assembly as claimed in claim 5, wherein a second angle of the second mark of the pick up cap points to one of the locating projections.

7. The connector assembly as claimed in claim 6, wherein the second mark of the pick up cap is extending from the top surface to the bottom surface.

8. A connector assembly comprising:
a connector comprising a connector body;
a clip pivotally mounted to a top portion of the connector body;
at least a first orientation means disposed on at least one of said connector body and said clip; and
a pick up cap comprising a body plate defining a second orientation means;
wherein the first orientation means is essentially closely aligned with said second orientation means when said pick up cap is correctly mounted to the clip.

9. The connector assembly as claimed in claim 8, wherein said first orientation means is located on the connector body and the first and second orientation means are aligned with each other in a front-to-back direction.

10. A connector assembly comprising:
a connector comprising a connector body assembly defining no flat top face thereof;
a first orientation means formed on the connector body assembly; and
a pick up cap comprising a body plate defining a second orientation means;
wherein the first orientation means is essentially closely aligned with said second orientation means when said pick up cap is correctly mounted to the clip.

11. The connector assembly as claimed in claim 10, wherein said connector body assembly includes a clip pivotally mounted thereon, and the first orientation means is located on said clip.
